(19) United States
(12) Patent Application Publication
(10) Pub. No.: US 2021/0073837 A1
(43) Pub. Date: Mar. 11, 2021

(54) A METHOD AND SYSTEM FOR GENERATING SURVEY RELATED DATA

(71) Applicant: Course5 Intelligence Private Limited, Redmond, WA (US)

(72) Inventors: Ravi Kumar Venkatesulu, Bengaluru (IN); Tamal Dutta Chowdhury, Bengaluru (IN); Manish Mittal, Mumbai (IN)

(21) Appl. No.: 17/053,521

(22) PCT Filed: May 3, 2019
(86) PCT No.: PCT/IB2019/053630

§ 371 Date: Nov. 6, 2020

(30) Foreign Application Priority Data
May 7, 2018 (IN) 201821017163

(51) Int. Cl. G06Q 30/02; G06Q 10/10; G06F 16/25; G06F 16/332; G06F 40/12

(52) U.S. Cl. CPC G06Q 30/0203; G06Q 10/10; G06F 40/12; G06F 16/3329; G06F 16/258

(57) ABSTRACT

The present invention generates survey related data, wherein unstructured documents comprising survey questions and table specifications is processed by dividing the text into a single token or series of tokens. Thereafter, a second document is created by assigning a unique identifier to each token or series of tokens, the unique identifier being in a machine readable format; and the unique identifiers in the second document are processed to create a third document based upon the unique identifiers, the third document comprising of text in a structured format.

### CROSS-REFERENCE TO RELATED APPLICATIONS

The present application claims priority to and is a national phase of PCT application serial no. PCT/IB2019/053630, filed May 3, 2019, which claims priority to Indian Patent application serial no. 201821017163, filed May 7, 2018, all herein incorporated by reference in their entireties.

### TECHNICAL FIELD OF THE INVENTION

The invention generally relates to a method and system for generating survey related data.

### BACKGROUND OF THE INVENTION

Conducting surveys and research is a common practice across industries/sectors for understanding market trends and improving decision making.

Nowadays, surveys are mostly conducted online. This is mainly due to availability/access to huge number of participants. Also, online surveys are effective in terms of time and cost. To create/generate online surveys, a questionnaire in form of a text documents is first prepared. Thereafter, each question/topic from the document is provided to a survey tool. Once all the required information is inputted on the survey tool, the survey link is checked for quality such as format, correctness of etc before the survey goes online. Thereafter, all the data received from the survey is collated and requisite result tables are populated/presentation charts are prepared in accordance with the business requirement of the organization. However, presently each of the steps of inputting survey information on the survey tool for generating a survey, checking survey link, collating data and providing the results require manual intervention. Thus, intensive manual effort is required, and turnaround time for generating the survey is also high. Further, also due to manual/human intervention chances of human error are also high.

Therefore, there exists a need in the art for addressing at least the abovementioned problems

### SUMMARY OF THE INVENTION

In one aspect, the present invention provides a method for generating survey related data, the method comprising the steps of receiving at a host system a first document, the first document comprising of text in an unstructured format, processing by a processor the text in the first document by dividing the text into a single token or series of tokens, creating/generating a second document by assigning a unique identifier to each token or series of tokens, the unique identifier being in a machine readable format, and processing the unique identifiers in the second document to create a third document based upon the unique identifiers, the third document comprising of text in a structured format.

In another aspect, present invention provides a system for generating survey related data, the system comprising a user-device for providing a first document, the first document comprising of text in an unstructured format; a host system comprising a processor configured to: receive the first document; process the text in the first document by dividing the text into a single token or series of tokens; create/generate a second document by assigning a unique identifier to each token or series of tokens, the unique identifier being in a machine readable format; and process the unique identifiers in the second document to create a third document based upon the unique identifiers, the third document comprising of text in a structured format.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 shows a flow diagram of a method for generating survey related data in accordance with an embodiment of the invention.

FIG. 2 shows a flow diagram of a method for generating survey related data in accordance with an embodiment of the invention.

FIG. 3 shows a system for generating survey related data in accordance with an embodiment of the invention.

### DETAILED DESCRIPTION OF THE INVENTION

The present invention is directed towards a method for generating survey related data. The invention generates surveys from unstructured documents containing survey questions and table specifications, wherein documents are automatically converted into a machine-readable script to generate survey scripts.

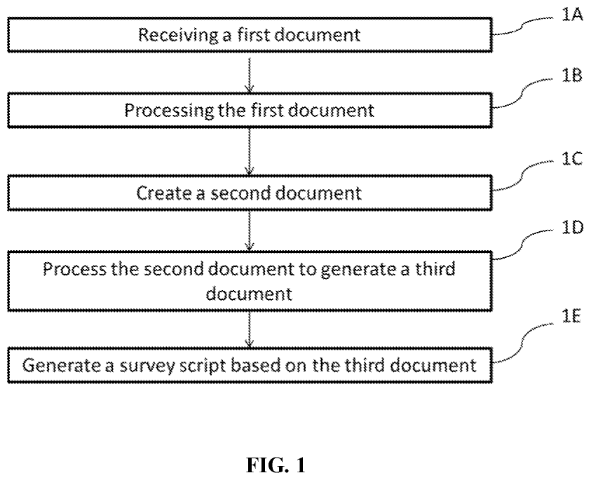

FIG. 1 shows a flow diagram of a method for generating survey related data in accordance with an embodiment of the invention. The method begins at step 1A where a first document is received/provided/imported. The first document may be unstructured and in any format. The first document comprises pre-determined parameters such as a set of questions, answer options associated with each question, properties associated with each question, and instructions associated with each question. Thus each question is associated with answer options, properties and instructions which establishes that the question is a single answer question or multi-answer question or grid question or open-ended question.

The method proceeds to step 1B where text from the first document is processed. Firstly, the text in the document is divided into tokens. Each token may be a word or a number or punctuation. A single token is representative of a word or a number or a punctuation, and a sequence of tokens is representative of a sentence or a paragraph which constitute the question, properties associated with each question, and instructions associated with each question. Thereafter, a second document is created at step 1C wherein each token or sequence of tokens is assigned/represented with a unique identifier. The unique identifier is in a machine readable format i.e. the second document will be a machine readable document. At step 1D, the second document is processed to analyze the unique identifiers, and generate a third document. Based on the unique identifiers, each question is reconstructed along with a relevant answer field, properties and instructions. In this regard, the answer field will be a single answer field or a multi-answer field or an open text field or a numeric field or a grid-type field or any other field type as necessitated by the source question. Thus, the third document is a structured document. At step 1E, the third document is provided to a platform to generate survey scripts, wherein each parameter obtained/identified is mapped to a pre-determined target scheme to obtain a desired format. Before, the survey script is generated, the survey script is reviewed by a subject matter expert via a web interface to correct any errors. The platform now is ready to host surveys and collect survey response data from one or more participants.

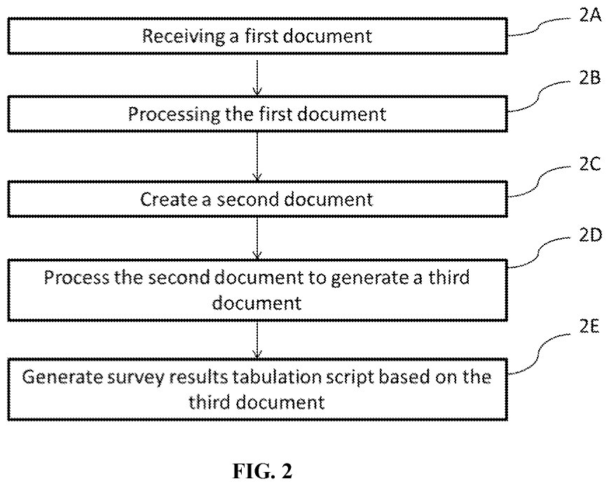

FIG. 2 shows a flow diagram of a method for generating survey related data in accordance with an embodiment of the invention. The method begins at step 2A where a first document is received/provided/imported; wherein the first document comprises a set of question identifiers, and data tabulation specifications associated with each question. From the data tabulation specification associated with each question, it can be established whether a particular question or response to the question should be a function such as mean, median, standard deviation, etc. The method proceeds to step 2B where text from the document is processed. Firstly, the text in the document is divided into tokens. Each token may be a word or a number or punctuation. A single token is representative of a word or a number or a punctuation, and a sequence of tokens is representative of a sentence which constitute the question identifier or a sentence or a paragraph which constitute the client specification. Thereafter, at step 2C a second document is created wherein each token or sequence of tokens is assigned/represented with a unique identifier. The unique identifier is in a machine readable format. At step 2D, the second document is processed to analyze the unique identifiers, and generate a third document. Based on the unique identifiers, each question is reconstructed along with the relevant data tabulation specification. In this regard, the tabulation specification field will be an aggregation function such as mean, median, standard deviation, etc. on the responses received for each question. Thus, the third document is a structured document. At step 2E, the third document is provided to a platform to generate survey data tabulation scripts, wherein each parameter obtained/identified is mapped to a pre-determined target scheme to obtain a desired format. Before, the survey data tabulation script is generated, the script is reviewed by a subject matter expert via a web interface to correct any errors. The platform now is ready to generate tables/reports/charts for one or more survey questions which have been responded.

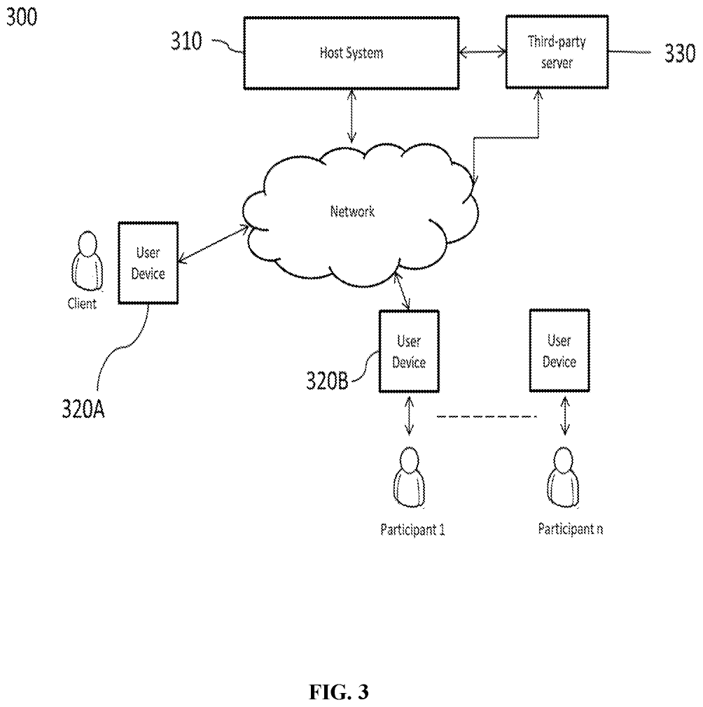

FIG. 3 shows a system 300 for conducting online surveys in accordance with an embodiment of the invention. The system as shown comprises a host system 310, wherein the host system is accessed through a user device 320A by a client, and by one or more participants through a user device 320B. The host system comprises of at-least a processor and a database. The client may provide the unstructured document to the host system via email or submit the unstructured document through an online portal. Alternately, the unstructured document may be provided to the host system locally. Once, the host system receives the document, the processor is configured to generate survey related data as discussed hereinbefore, wherein an unstructured document is processed by the host system to generate a survey script which may be hosted on the host system or a third-party server 330. The participants can access the survey and provide their responses to the survey through their respective user-devices. The user-devices at-least comprises of one or more processors, a memory, a communication module, a display or interactive touch-screen display, input/output devices, etc. The user-devices may be electronic devices or portable devices such as smart phones, laptops, tablet pc, etc. In this regard, the host system may be accessed through an application installed on the user device.

Advantageously, the present invention generates survey scripts from unstructured documents.

While the present invention has been described with respect to certain embodiments, it will be apparent to those skilled in the art that various changes and modification may be made without departing from the scope of the invention as defined in the following claims.

We claim:

1. A method for generating survey related data, the method comprising the steps of:
receiving at a host system a first document, the first document comprising of text in an unstructured format;
processing by a processor the text in the first document by dividing the text into a single token or series of tokens;
creating/generating a second document by assigning a unique identifier to each token or series of tokens, the unique identifier being in a machine-readable format; and
processing the unique identifiers in the second document to create a third document based upon the unique identifiers, the third document comprising of text in a structured format.

2. The method as claimed in claim 1, wherein the text in the unstructured format comprises set of questions, answer options associated with each question, properties associated with each question, and instructions associated with each question.

3. The method as claimed in claim 1, wherein the text in the structured format comprises reconstructed set of questions, each question along with a relevant answer field, properties and instructions.

4. The method as claimed in claim 3, wherein the answer field is a single answer field or a multi-answer field or an open text field or a numeric field or a grid-type field or any other field type as necessitated by the question.

5. The method as claimed in claim 1, wherein the text in the unstructured format is a set of question identifiers, and data tabulation specifications associated with each question, the data tabulation specification establishes whether a particular question or response to the question should be a filter, a query or a function such as mean, median, standard deviation, etc.

6. The method as claimed in claim 1, wherein the text in the structured format is reconstructed questions with the relevant data tabulation specification.

7. A system for generating survey related data, the system comprising:
a user-device for providing a first document, the first document comprising of text in an unstructured format;
a host system comprising:
a processor configured to:
receive the first document;
process the text in the first document by dividing the text into a single token or series of tokens;
create/generate a second document by assigning a unique identifier to each token or series of tokens, the unique identifier being in a machine readable format; and
process the unique identifiers in the second document to create a third document based upon the unique identifiers, the third document comprising of text in a structured format

8. The system as claimed in claim 7, wherein the text in the unstructured format comprises set of questions, answer options associated with each question, properties associated with each question, and instructions associated with each question.

9. The system as claimed in claim 7, wherein the text in the structured format comprises reconstructed set of questions, each question along with a relevant answer field.

10. The system as claimed in claim 9, wherein the answer field is a single answer field or a multi-answer field or an open text field or a numeric field or a grid-type field or any other field type as necessitated by the question.

11. The system as claimed in claim 7, wherein the text in the unstructured format is a set of question identifiers, and data tabulation specifications associated with each question, the data tabulation specification establishes whether a particular question or response to the question should be a filter, a query or a function such as mean, median, standard deviation.

12. The system as claimed in claim 7, wherein the text in the structured format is reconstructed questions with the relevant data tabulation specification.
